(19) United States
(12) Patent Application Publication
(10) Pub. No.: US 2026/0346178 A1
(43) Pub. Date: Nov. 5, 2026

(54) SYSTEM AND METHOD FOR CREATING AN AIR FILTER ALLOWING COMPACT PACKING

(71) Applicant: WOOSH AIR INC., San Francisco, CA (US)

(72) Inventor: Winston Mok, San Francisco, CA (US)

(21) Appl. No.: 19/637,197

(22) Filed: Apr. 2, 2026

Related U.S. Application Data
(60) Provisional application No. 63/799,074, filed on May 2, 2025.

(51) Int. Cl. B01D 46/52; B01D 46/44; B01D 46/58

(52) U.S. Cl. CPC B01D 46/522; B01D 46/446; B01D 46/523; B01D 46/58; B01D 2271/025; B01D 2279/50

(57) ABSTRACT

A deep air filter media suitable for industrial applications that allows compact storage is disclosed. The deep air filter media has a plurality of air filter media sections having deep depth filter pleats. Each air filter media section has a top end with pleat openings for entry for air to be filtered and a bottom end with closed pleats for exit of the filtered air. The air is filtered through the filter media of the pleats. The pleats have a triangular cross section. A plurality of semi-rigid side seals cover the open side edge of the pleats. The bottom ends of the filter pleats of one air filter media section are insertable between the bottom ends of the filter pleats of a second filter media section allowing stacking of the first air filter media with the second air filter media.

### PRIORITY CLAIM

This application claims the benefit of, and priority to U.S. Provisional Patent Application No. 63/799,074 filed on May 2, 2025, which is hereby incorporated by reference herein in its entirety.

### TECHNICAL FIELD

The present disclosure generally relates to pleated flat air filters used in residential, industrial, and commercial applications. Specifically, this disclosure relates to a replacement air filter media segment that is insertable in a dedicated filter frame to be used as a filter, where the replaceable filter media segment allows for stacking mainly for reducing the volume required for storage.

### BACKGROUND

Heating, ventilation, and air conditioning (HVAC) are systems that have become common staple in providing indoor comfort and dust proofing in residential, industrial, and commercial buildings. The overall goal of such a system is to provide thermal comfort, as well as an acceptable indoor air quality with low particle count that is suitable to breathe and work in. HVAC systems are also needed for reducing damage due to particles to material in industrial settings. These systems have become an important part of residential, commercial and Industrial structures including single family homes, apartment buildings, hotels, and senior living facilities, medium to large industrial and office buildings and complexes such as those in skyscrapers and hospitals, where safe and healthy building conditions are regulated and ensured with respect to temperature, humidity, and air quality by using an in-flow of fresh air from outdoors.

In order to use the fresh air from the outdoors, proper ventilation for the buildings must be provided. Ventilation is the process of exchanging or replacing air in any space, to provide high indoor air quality. High indoor air quality involves temperature and humidity control, oxygen replenishment, and removal of unwanted odors, smoke, heat, dust, airborne bacteria, and other contaminants and gases from the air. Ventilation also facilitates the removal of unpleasant smells and excessive moisture by introducing fresh outside air to keep interior building air circulating to prevent stagnation of the interior air. Air filters are an essential component of the ventilation system. HVAC systems typically have air cooling and air warming sub-systems that enable distribution of cooled or heated air through duct work systems as necessary. The air supply intake is filtered through air cleaners and filters to remove dust, bacteria, and particles such as pollen particles. Failure to replace filter media regularly in such a system could lead to reduced air exchange capability and lower heat exchange rate, resulting in wasted energy, shortened equipment or system life, and higher energy bills. In some instances, unclean or dirty air filter media that have been kept in the system beyond their lifespan can cause system overheating during operation, resulting in damage to the system or a fire.

Changing the filter media regularly reduces the strain on the equipment used to circulate the air. The regular changing of filters also helps prolong the life of the HVAC system and reduces overall energy consumption. In addition to providing adequate air flow to protect the equipment, these air filters purify the air for the occupants within a residential or commercial setting by removing un-wanted polluting contaminants. Air filters with filter media of increasing efficiency, capable of filtering out smaller size particles and contaminants, have become more popular as consumers have become more aware and interested in indoor air quality (IAQ).

Air filters are often selected from groups consisting of a pleated type or a non-pleated type. Pleated filters often allow for more air filter media surface area, resulting in less pressure drop across the filter and hence less energy use in order to filter the incoming air. Non-pleated air filters have a smaller surface area of the filter media for filtration and result in a shorter filter media use life and thus provide results that are less optimum than the pleated air filter. These non-pleated filters with non-pleated filter media are mainly used where cost is the main concern. Typically, pleated air filters have pleated air filter media of a rectangular shape that have standardized length, width, and depth. In current filter designs the filter media occupies only a fraction of the total volume and weight of the assembled air filter.

Most of the weight of an assembled air filter media section is made up of the cardboard structural frame that holds the pleated media of the air filter, the galvanized steel mesh used over the filter to support the filter pleats of the filter media, and adhesive that holds the entire assembled cardboard structural frame and the air filter media together. However, these typical air filter media sections are not compressible, crushable, or foldable due to the semi-rigid cardboard structural frame and steel mesh. In order to ship the assembled air filters to consumers, the assembled filter media sections are stacked one over the other and shipped in rigid box to protect them from damage while in transport where each air filter media section uses its total volume in the package. Hence packing, transport and storage cost of these filters form a substantial portion of the total cost of each assembled filter.

As discussed above most of the cost of typical replaced air filter media sections today is due to the structural components required to hold the filter media in place and provide the needed shape to the filter. The cost may, in some cases, also include the cost of sensors and electronics needed for monitoring the air quality when using these filter media if they form part of the filter media section. Pending U.S. Serial No. 17/592,319 filed on Feb. 3, 2022 titled: “Collapsible and Foldable Pleated Disposable Air Filter” and pending U.S. Serial No. 17/674,626 filed on Feb. 17, 2022, titled “Frame For Collapsible and Foldable Pleated Disposable Air Filter With Differential Pressure Sensor and Communication Capability” describe air filters and frames that eliminate the high cost structural rigidity providing components and sensors of the current air filters. However, these applications do not fully address the cost of packing, transport and storage of the replacement industrial filter media. Industrial filter systems currently use 4 inch or 5 inch deep pleated filter media due to their advantage in providing a high area for air filtration with reduced drop in air pressure across the filter media. These filters also have a longer life allowing longer use between replacements of the filter media. Although the 4 and 5 inch pleated filters are mainly used in residential applications today, they may also be used in commercial and industrial applications.

As discussed before one of the main costs associated with the replacement filters is the cost of transporting the filter media section. This cost includes sending or transporting the filters to the consumer, and the cost of the volume of space required for packing and storing the filter media sections due to their larger size, which can have a direct additional impact on the cost of using these filter media sections. Typically, these larger filter media sections, unlike the one or two inch filter media, are not easily folded for transport and storage. Due to their deep filter pleats, the 4 and 5 inch filter sections require protection from damage to the pleats when stacking even for transport and storage. The deep pleats of the 4 and 5 inch filter module sections also need to have sufficient rigidity or be provided with support to prevent undue distortion due to air pressure during operation.

Thus, there is a need for a filter media construction that makes the filter media sections stackable in a smaller volume for transport and storage. There is also a need for deep filter media sections that are reinforced and protected to prevent damage to the pleats during stacking for transportation and storage and also during filter operation. There is also a need for reducing additional cost associated with the sections of filter media arising from adding differential air pressure sensors and other sensors for monitoring the air filter operation.

### SUMMARY

The term embodiment and like terms, e.g., implementation, configuration, aspect, example, and option, are intended to refer broadly to all of the subject matter of this disclosure and the claims below. Statements containing these terms should be understood not to limit the subject matter described herein or to limit the meaning or scope of the claims below. Embodiments of the present disclosure covered herein are defined by the claims below, not this summary. This summary is a high-level overview of various aspects of the disclosure and introduces some of the concepts that are further described in the Detailed Description section below. This summary is not intended to identify key or essential features of the claimed subject matter. This summary is also not intended to be used in isolation to determine the scope of the claimed subject matter. The subject matter should be understood by reference to appropriate portions of the entire specification of this disclosure, any or all drawings, and each claim.

According to certain aspects of the present disclosure, an example air filter media is disclosed. The air filter media includes a plurality of pleated filter media sections of deep depth configured to be inserted and enclosed in a filter frame. Each filter media section has a top end, a bottom end, and opposing sides. The top end of each of the filter media sections comprise a plurality of pleats. Each of the plurality of pleats has an opening at the top end of the filter media section for unfiltered air entry. The plurality of pleats at the bottom end of each of the filter media sections comprise closed pleats allowing air within the pleats to filter through the filter media and exit the filter media section as filtered air. Each of the plurality of pleats have an open end at the top end and a closed end at the bottom end having a triangular cross section. The plurality of pleats include open pleat edges on the opposing sides of the filter media. The filter media includes a plurality of semi-rigid side seals that each have a plurality of triangular shapes conforming to a cross-section of the pleats. The side seals cover and close the open side edges of each of the pleats of each of the plurality of sections of filter media. The bottom ends of the filter pleats of one filter media section are insertable between the bottom ends of the filter pleats of a second filter media section allowing back to back stacking of the air filter media sections.

A further implementation of the example air filter media includes a rigid comb configured to be inserted and integrated into the pleats. Another implementation is where integration of the comb includes gluing the comb into the pleats of the filter media pleats to provide rigidity and structural integrity to the deep pleats of the filter media section. Another implementation is where the rigid comb includes a spine and a plurality of comb fingers that extend into the pleats of the filter media section and are glued in place. Another implementation is where the side seals are glued to the open side edges of the pleats to close them and prevent an air leak. Another implementation is where the top of the side seals for closing the open side edges of the pleats of each of the plurality of sections of filter media provide a border edge seal for the corresponding two sides of the filter media section. Another implementation is where the border edge seals of the remaining two sides of the filter media section are formed by hot press of the filter media. Another implementation is where the semi-rigid side seals are fabricated from a material of higher rigidity and of higher filtration efficiency than the rigidity and filtration efficiency of a filter media material used for the pleats of the filter media section. Another implementation is where the example air filter media includes an additional compressible seal attached over the border edge seals of the filter media section to prevent air leaking around the air filter media section when the filter media section is enclosed in a filter frame and the filter is in operation filtering air. Another implementation is where the deep depth filter pleats have a depth of between 4 to 6 inches.

Another disclosed example is an air filter for deep depth filter media that includes one or more deep depth filter media sections. Each of the one or more deep depth filter media sections comprise a plurality of deep depth filter pleats. Each pleat is made of filter media material and has a closed bottom end and an open top end with a triangular cross section. Each of the deep depth filter pleats extend from one side of the filter media section to the opposite side and each of the deep depth filter pleats have two open side edges. The deep depth filter media sections include one or more combs. Each of the combs includes a rigid spine with comb fingers fitting the triangular cross section shape of the pleats extending therefrom. The one or more combs are inserted into the deep depth filter pleats and integrated by glue to the inside of the pleats to provide rigidity and structural integrity to the plurality of deep depth filter pleats. The deep depth filter media sections each include two semi-rigid side seals made from a material having a higher filtration efficiency than the filter media. The seals are die cut to fit and cover only the two open side edges of the plurality of pleats of one of the filter media sections. A frame has a frame top and a frame base. The frame base includes a filter bottom with one or more compartments, each compartment holding one of the deep depth filter media sections. The bottom of the filter pleats of a first filter media section are insertable between the bottom of the filter pleats of a second filter media section allowing back to back stacking of the filter media sections.

A further implementation of the example air filter is where the plurality of deep depth filter pleats are between 4 and 6 inches in depth. Another implementation is where the frame includes one or more compartments for holding the deep depth filter media sections, where the compartments are separated by a divider. Another implementation is where the divider holds a differential air pressure sensor. Another implementation is where the frame base includes one or more communication modules, and power supply modules used in a filter system. Another implementation is where the frame top is connected by hinges to one side of the frame base. Another implementation is where each of the one or more filter media sections have an outer border edge seal that is compressed between an edge of the frame base or a divider in the frame base and an edge or a corresponding divider, to the one in the frame base, of the frame top when the filter is closed to prevent air leak around the filter media section and hold the filter media section securely within the closed filter frame during operation.

Another disclosed example is an air filter media section including a plurality of 1 to 2 inch deep filter media sections. Each of the plurality of 1 to 2 inch deep filter media sections have a plurality of 1 to 2 inch deep filter pleats. The filter media sections are storable with interleaved filter pleats in a front to back stacking. The plurality of 1 inch to 2 inch deep filter media sections are sufficient rigid to prevent deformation when interleaved during the front to back stacking.

A further implementation of the example air filter media is where the front to back stacking with interleaved pleats reduce the volume required for storing of the air filter media sections. Another implementation is where the 1 to 2 inch deep filter media sections are foldable and disposable.

The above summary is not intended to represent each embodiment or every aspect of the present disclosure. Rather, the foregoing summary merely provides an example of some of the novel aspects and features set forth herein. The above features and advantages, and other features and advantages of the present disclosure, will be readily apparent from the following detailed description of representative embodiments and modes for carrying out the present invention, when taken in connection with the accompanying drawings and the appended claims. Additional aspects of the disclosure will be apparent to those of ordinary skill in the art in view of the detailed description of various embodiments, which is made with reference to the drawings, a brief description of which is provided below.

### BRIEF DESCRIPTION OF THE DRAWINGS

The accompanying figures are included to provide an understanding of the invention and are incorporated in and constitute a part of this specification. The figures are exemplary and illustrate some of the embodiments of the invention and, together with the description, serve to explain the principles of the invention. The drawings and their descriptions are not to be considered limiting. The invention may be modified and implemented by practitioners of the art in ways other than that shown in the drawings to meet the requirements of specific air filtration systems.

The foregoing and other objects, aspects, features, and advantages of the disclosure will become more apparent and better understood by referring to the following description taken in conjunction with the accompanying exemplary drawings of a preferred embodiment.

Elements in the figures are illustrated for simplicity and clarity and are not to be limiting. Hence the figures included have not been drawn to scale and are not to be considered manufacturing drawings. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required and can be changed to fit the design and manufacturing needs. The terms and expressions used herein have the ordinary technical meaning as is accorded to such terms and expressions by persons skilled in the technical field as set forth above except where different specific meanings have otherwise been set forth herein.

FIG. 1 shows an example filter with deep filter sections and a filter frame.

FIG. 2 is a perspective view of the filter in FIG. 1, with one of two filter sections of an air filter media inserted in the frame.

FIG. 3 is an exploded perspective view of a filter section in FIG. 1.

FIG. 4 is a perspective view of comb structures and the filter section in FIG. 1.

FIG. 5 shows a side view of one of the comb structures in FIG. 4.

FIG. 6 shows a perspective view of the example filter section in FIG. 1 with the comb structures inserted.

FIG. 7 shows a perspective view of two filter sections in FIG. 1 prior to packing.

FIG. 8 shows a perspective view of the two filter sections in FIG. 7 stacked back to back in an interlaced manner for saving volume in packing.

FIG. 9A shows a perspective view of a set of another example pleated foldable disposable filters ready to be stacked.

FIG. 9B shows a cutaway side view of the four filters along the line X-X in FIG. 9A.

FIG. 9C shows a cutaway side view of the example four filters in FIG. 9A interwoven and stacked.

FIG. 9D shows a close-up perspective view of the example four filters in FIG. 9A interwoven and stacked.

### DETAILED DESCRIPTION

Currently typical large residential filters use rectangular 4 or 5 inch deep pleated flat filter sections in a cardboard frame, reinforced by metal grating, that may be fit in a corresponding filter slot or return air grille. These filter sections are a stacked one on top of the other for transport and storage. This stacking of replacement filter sections requires side protection provided by the 4 or 5 inch rigid cardboard side covers to prevent damage to the filter media during stacking for transport and storage. Hence the stacking occupies twice the volume of a filter section. If this volume can be reduced it will be very advantageous to ship and store the filter. The current disclosure relates to a filter design with disposable pleated filter media sections and a reusable frame that allow disposable pleated flat filter media sections to be inserted into the reusable filter frame forming the air filter. The 4 and 5 inch filter media sections are provided with additional rigidity and support optionally, when required, using an integratable comb structure, to prevent pleat deformation during use as well as during stacking for storage and transportation. The disposable 4 and 5 inch filter media sections are designed to allow two of them to be packed back to back, saving over 30-46% in storage volume compared to the current filter section stacking. The optional integrated rigid comb can be inserted and integrated into the filter pleats of low rigidity filter media to reduce pleat deformation while packing, storing and operation.

As discussed above, most residential, commercial, and industrial applications for air filtering especially within large HVAC systems prefer to use 4 inch or 5 inch deep pleated filter media sections in the filters. There are filters of many shapes and sizes to fit various applications including flat filters. The example flat filters described herein typically comprise at least two sections of pleated filter media, having a plurality of pleats to be inserted into two compartments of the reusable filter frame. The use of two filter media sections enable back to back stacking as will be described thus reducing the volume for storage and transport. Though two filter media sections are commonly used, other numbers of filter media may be used. Each of the example filters may comprise one, two or more filter media sections. Each filter media section has a top side where the pleats are open to admit the air to be filtered into the pleats of the filter media and a bottom side where the pleats are closed and the filtered air exits through the filter media of the pleats and the filter media section. The pleats extend from one side of the filter media section to the other and have a triangular cross-section. The pleat edges are open at the sides. Typically the cross-section is of an isosceles triangle with the apex at the closed bottom. The open top forms the base and the two sides form the pleat pocket where the two sides typically have equal lengths. Other shapes and arrangements may be used for the pleats.

The example air filters described provide advantages that supersede currently available solutions. The example air filters are a 5 or 4 inch flat industrial filter that may include two or more sections of filter media having a plurality of pleats with side seals. In this example, the pleats are 5” in depth and two filter media sections make up the filter. The two filter media sections are configured to fit securely within a filter frame enabled to hold the two sections of the filter media securely. The open sides of the filter pleats are sealed typically by a more rigid and strong material, such as felt or cardboard. The side seals are shaped to cover the open pleat sides only and are glued to the pleat edges on either side of the filter section to prevent leakage from the sides of the open edges of the pleats.

The open sides of the filter pleats are sealed typically by a more semi-rigid material, such as felt or cardboard, forming a side seal. The side seal conforms to the shape of the pleats. The side seals are hence shaped to cover the open pleat sides only and are glued to the pleat edges on either side of the filter section to prevent leakage from the sides of the open edges of the pleats. The semi-rigid and strong material used to seal the open sides of the pleats have to be one of higher filtration efficiency than the material used for the filter to prevent the air flow through the sides of the filter rather than the pleats of the filter.

Hot glue or quick setting adhesive may be applied to a die cut semi-rigid and strong material used as side seal material for the sides of the pleats and the die cut side seal stuck to the pleats to close the open sides of the pleats and provide the side seal to close the open sides of the pleats. The top of the semi-rigid side seal may also be used to make a border seal for the filter media section.

The shaping of the side seal is an enabler for stacking the filter media sections back-to back to save 30 to 46% volume of the two stacked sections compared to the current front to back packing.

The border seals of the filter sections may comprise a hot formed or glued fold of the semi-rigid seal material used. The filter media are manufactured as standardized filter media segments (irrespective of the depth of 4 or 5 inches) of appropriate depth, that fit into each of the associated frame sections. The filter media sections are to be inserted into the filter frame base and securely sealed by a frame top. The filter media sections are disposable and replaceable.

A filter frame typically is made to fit specific standard sizes of the equipment wherein the filter is to be used. The depth of the example filter pleats defines the depth of the frame. The filter frame provides the necessary support to the filter media segments and seals the filter media segment within the frame, preventing leakage of air around the filter media edges during operation.

An edge gasket attached to the filter media sections is placed over the border edge seals and compressed between the edges of the filter frame bottom and filter frame top to further ensure that there is no air leak around the edges of the filter media sections enclosed within the filter frame during operation. The edge gasket may be made typically with a material similar to that used for filter media. The edge gasket may be attached to the filter media sections using hot press or by using glue. The edge gasket may also help the user to pull out the filter media sections for replacement. The filter frame may be held closed by use of external latches or magnets attached to the frame top and bottom.

The filter frame may be used to carry sensors. The sensors may include a differential air pressure sensor and other sensors used to gauge the quality and other characteristics of the filtered air. Thus, the other sensors may include temperature and humidity sensors. The frame may also hold optional electronic circuits such as a communication module, a sensor change indicator, and power-on/off switches that operate when the blower is operational. The filter frame may also hold Hall effect sensors that detect the open or closed state of the filter cover.

The sensors, control module, and communication module may be installed on the reusable frame at the time of manufacture or optionally at the time of installation by a technician. By having the sensors, control module, and communication module installed on the reusable filter frame and not the disposable filter media sections, the cost of filter media section replacement is reduced.

The filter media sections are made without any additional side protection except using the shaped rigid material enabled for back to back stacking with the back of the filter pleats engaged one inside the spacing of the other when stacked back to back.

The deformation of the pleats of the filter section when the filter material used for the media is not of high rigidity is improved by use of a rigid comb inserted and integrated within the pleats. When the filter material has sufficient rigidity to prevent deformation due to the stacking the rigid comb insertion and integration with the filter section may be eliminated.

The comb is inserted in the direction of flow of the air and glued to the pleats. This integrates the comb structure into the pleats of the filter media section to space the pleats correctly and reduce the deformation of the pleats during stacked storage and operation.

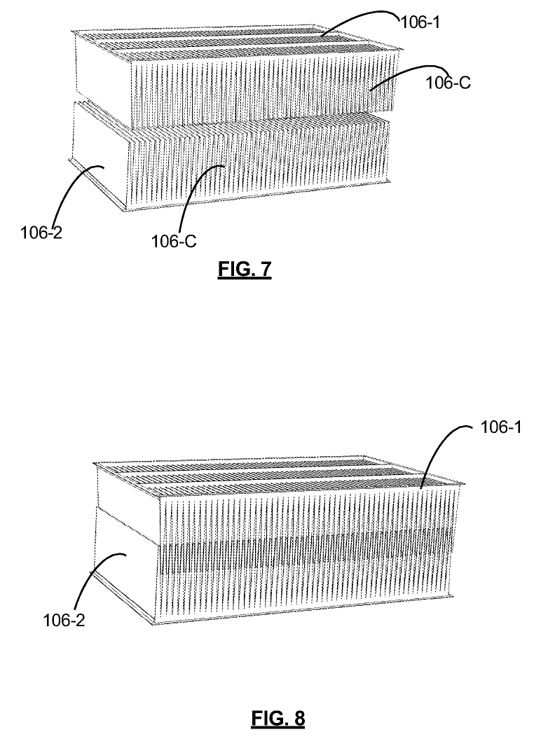

Each comb structure comprises a rigid spine (501) and comb fingers (502) as shown in FIG. 5. The comb structure is made of a rigid material and is fixed and glued in place within the pleats of the filter media section. The comb structures are thus attached to and integrated into the pleats of the filter media and enable the pleat separation and improve the rigidity and operational integrity of the deep depth pleats.

Two combs are shown used in this example. However, more or less than two combs may be used depending on the rigidity of the filter material used for the construction of the pleats of the filter sections. The insertion and integration of the combs in front of the filter media sections in the direction of the airflow enable the filter sections to be stacked back to back for storage.

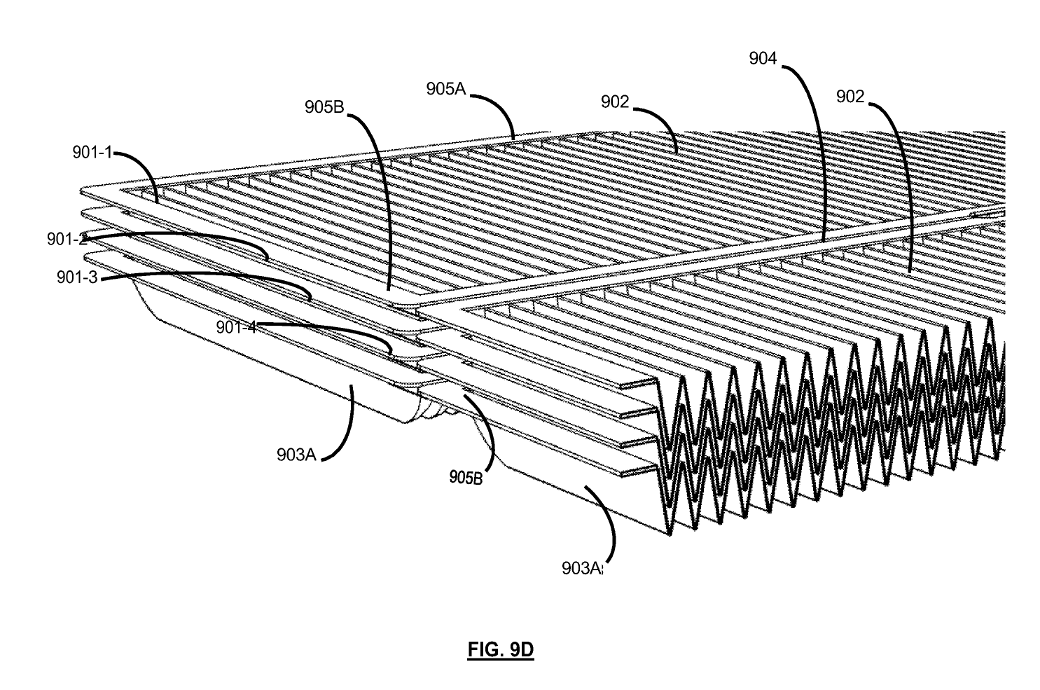

The structure of the filter section structure also allows the stacking of smaller depth 1” and 2” foldable disposable filter sections (901-1 to 901-4) shown in FIGS. 9A-9B having one or more strips of filter media are joined together at a foldable seam (904). Each strip (902) of filter media has a plurality of filter pleats (903B). The open edges of the filter strips are sealed using a hot press that also forms an edge seal (905-A and 905-B). These filter media sections (901-1 to 901-4) are stacked front to back with the pleats (903-B) interleaved rather than back to back as with the deep depth filter media sections with comb structure integrated. The integrated comb structure prevents multiple of these filter media sections from being stacked with interleaved pleats while allowing back to back packing of two of the filter media sections as described herein. When stacked, the 1 to 2 inch filter elements are stacked with interleaved pleats with no additional support such as combs, due to the short depth of the filter media sections made from filter media material with a built in support layer providing them with enough rigidity and structural integrity. This front to back stacking with interleaved pleats allows for a substantial reduction of storage volume for multiple 1 to 2 inch filter media sections during storage.

The disclosed example filter has the following advantages including the ability to form the disposable 1 inch to 5 inch deep filter sections, which enable stacking. The four and five inch filter media sections in a back-to back stacking and the one to two inch filter media sections in a front to back stacking reduce the volume needed for transporting and storing them. The features allow a method of stacking these large (4 and 5 inch deep) filter media sections back to back and the smaller (1 and 2 inch deep) filter media sections front to back to save space. Additional rigidity is provided to the 4 and 5 inch low rigidity filter media by integration of a comb structure to prevent damage during stacking for transporting and storing. Filter border edges have hot formed or hot glued seals to prevent air leakage along the filter section sides. The border seals may have over laying gaskets that are compressed by the edges of the filter frame and the dividers to hold the filter media sections firmly within the filter frame. The dividers of the filter frame allow sensors including a differential air pressure sensor to be held thereon reducing the cost of the replaceable filter media sections. The design also allows the ability to stack shorter 1” and 2” pleated foldable and disposable pleated filters media sections of a similar structure to be stacked front to back to save storage volume.

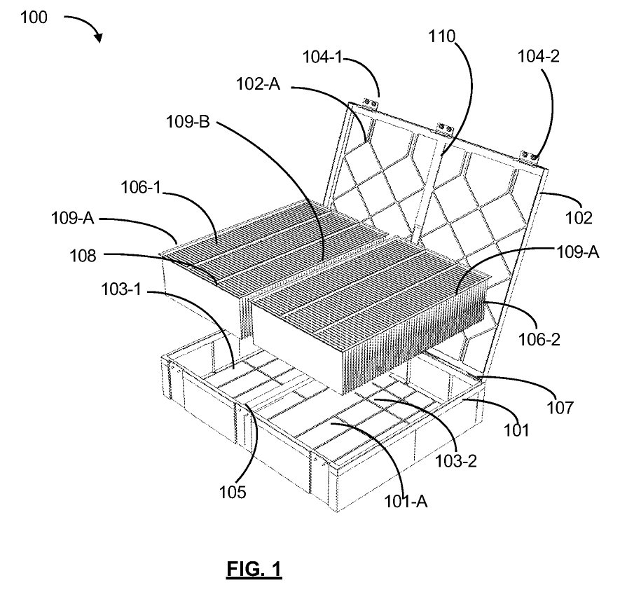

FIG. 1 shows an exemplary 5” deep pleated HVAC air filter 100 having a filter frame. The filter 100 with a filter bottom having edges (101) with a filter grid at a bottom (101-A) as a support for filter media sections (106-1 and 106-2). The filter media sections 106-1 and 106-2 are insertable within compartments (103-1 and 103-2). The filter bottom is shown as having two compartments (103-1 and 103-2) for holding the two filter media sections (106-1 and 106-2). The two compartments (103-1 and 103-2) are separated by a central divider (105).

The central divider (105) may be used to hold a differential air pressure sensor. The frame and the central divider (105) may also be used to hold other sensors used to check for air quality, one or more communication modules and power supply modules and the like that are used in the filter system.

The filter has a frame top (102) connected by hinges (107) to one side of the frame base. The frame top (102) acts as a cover for the filter media sections within the frame to hold the filter media sections (106-1 and 106-2) in place during operation. The filter media sections (106-1 and 106-2) have outer border edge seals (108 and 109-A) compressed between the edge (101) of the frame bottom and the edge of the frame top (102). Inner border edge seals (109-B) of the filter media sections (106-1 and 106-2) are compressed between the top divider (110) and the bottom divider (105). The compressed seals (108, 109-A, and 109-B) at the border edges thereby hold the filter media sections (106-1 and 106-2) in place when air flows through the sections (106-1 and 106-2) during operation of the filter. The frame top (102) is shown with latches (104-1, and 104-2) that latch the filter frame closed during operation. Alternate closure methods such as a magnetic closure of the frame may be employed instead of the latch.

The frame top (102) also has filter grids (102-A) providing support to the filter media sections (106-1 and 106-2) in the two compartments (103-1 and 103-2) of the filter frame. Although the filter frame and filter media sections in this example have a 5” depth, other depths may be used. For example depths of between 4 or more inches may be used for industrial applications. The depth of the frame may be based on the depth of the air filter media. Although the example filter frame has two sections, the filter frame can have one section or more than two sections to hold an appropriately shaped air filter media.

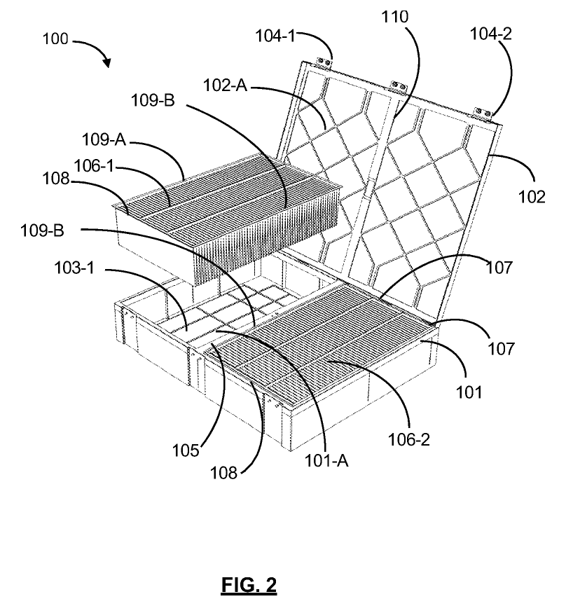

FIG. 2 is a perspective view of the frame of the air filter 100 that supports the exemplary 5” deep industrial filter with the filter media section 106-2 inserted into the compartment 103-2 in FIG. 1A. Like elements in FIG. 1 are labeled with like reference numerals in FIG. 2. As will be explained the example filter sections (106-2) include filter folds, a comb structure in the filter pleats, and a rigid shaped side coverage of the filter pleats that prevent air leakage from the open filter pleat edges. The frame has two sections (103-1 and 103-2) used to hold the two filter sections with a central divider (105) capable of holding sensors comprising at least a differential air pressure sensor, power, control and communication electronics and magnetic closure devices for holding the frame closed. Each of the filter sections (106-1 and 106-2) have additional border edge seals that are configured to hold the sections securely within the frame without air leakage around the filter edges.

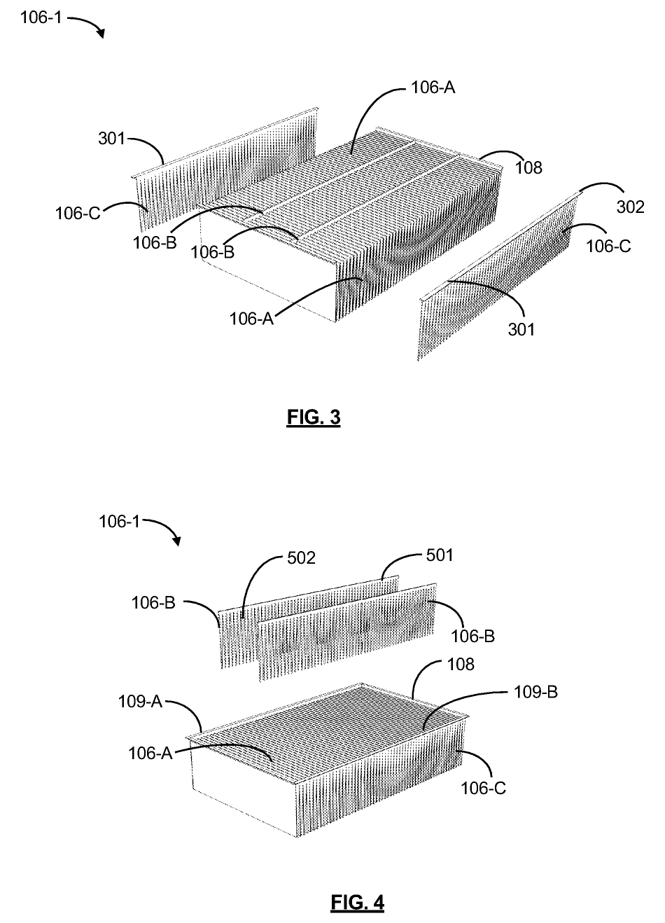

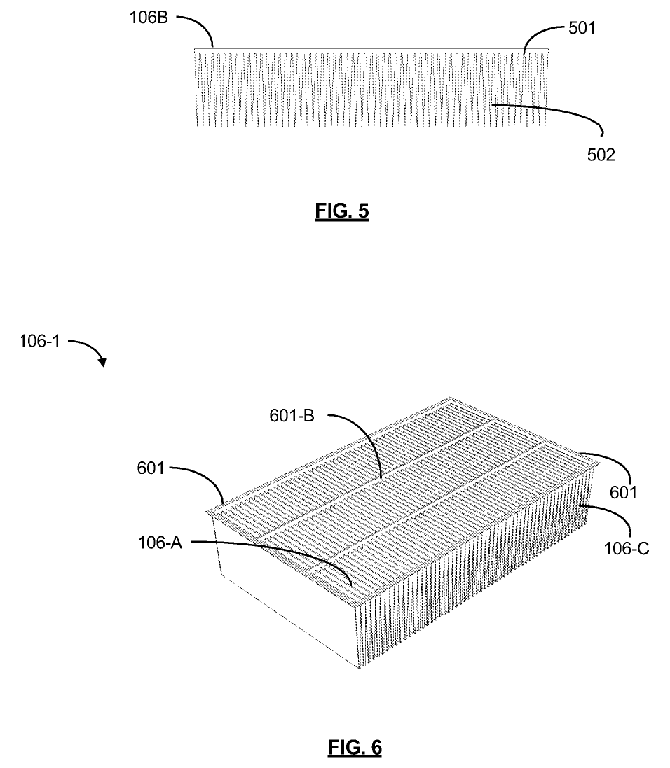

FIG. 3 is a close-up perspective view of one of the filter media sections 106-1 in FIG. 1A. The filter media section 106-1 includes a pleated filter media (106-A) having sections of deep depth filter pleats of 4 or 5 inch depth. One or more rigid combs or comb-structures (106-B) having comb fingers of a depth similar to the depth of the filter media and the comb finger shape to fit the triangular cross section of the pleats are inserted in the pleated filter media (106-A) as shown in FIG. 4. The comb structures (106-B) in this example are made of a rigid material. The comb structures (106-B) are inserted and glued on to the pleats to integrate them into the pleats of the filter media to provide a rigidity to the 5” deep pleats of the pleated filter media (106-A) during packing and transportation and to reduce deformation of pleats during operation. If the filter material used for the pleats is of sufficient rigidity, the use of combs (106-B) integrated into the pleats can be reduced or the comb structures may be eliminated altogether. The number of combs used will hence depend on the rigidity of the filter material used.

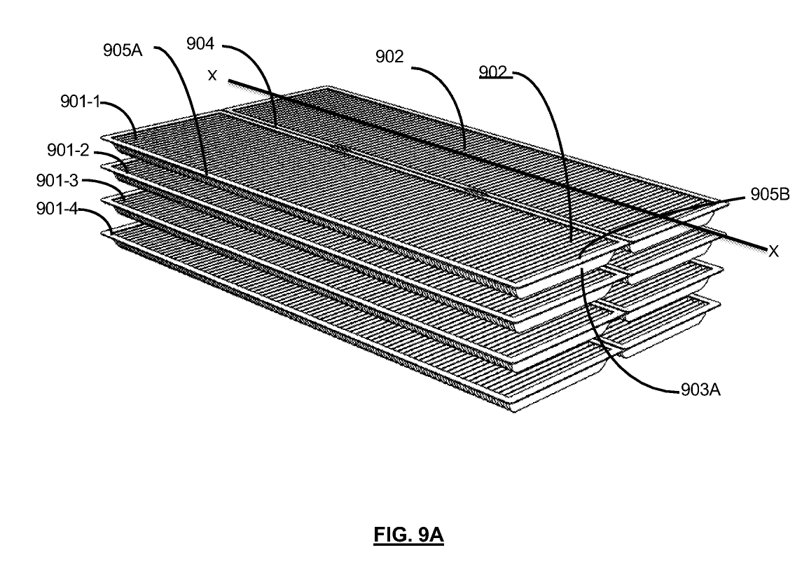

Two rigid side panels (106-C) made of semi-rigid material having a high filtration efficiency are shaped to cover the side holes of the filter pleats. The side panels (106-C) are typically die cut to cover and close only the open pleat ends and hot glued in place on the sides of the pleats (106-A) to prevent air flow from the sides of the pleats. FIG. 3 shows the two side panels (106-C) separated from the pleated filter media (106-A). Using a semi-rigid material of higher rigidity than the filter material of the pleats also enables the side panels (106-C) to strengthen the pleats during packing and operation. The side panel material is typically also used for creating outer border edge seals (301) and preferably a seal extension (302) of the filter section (106-1). The seals 108 are the seal along the width of the filter media section and the seals 109A-109-B are the seals on the length of the filter media section. The seals 108 are typically formed in all filter media sections by hot forming of the filter media material. The seals 109-A and 109-B in the 1 to 2 inches deep filter media section are also formed by hot forming of the filter media material but in the case of the large filter media sections it is formed as a seal 302 forming part of the side panels to be attached to the pleats. The seal 301 extends over the edge of the seal 108 and is integrated with the seal 108 before the gasket or a compressible seal 601 is attached as shown in FIG. 6.

FIG. 4 shows a perspective exploded view of the filter media section (106-1) with the rigid side panels (106-C) in place and the comb structures (106-B). As explained above, the comb structures (106-B) are formed of a rigid material separated from the pleats of the pleated filter media. In this example, the comb structures (106-B) provide additional rigidity to the filter pleats of the filter media sections (106-1 and 106-2) when they are being packed back to back to reduce the volume for transport and storage.

FIG. 5 shows a side view of the structure of the rigid comb structure (106-B) in FIG. 4. The comb structure (106-B) includes a rigid spine (501) from which the comb fingers (502) extend. The comb fingers (502) are spaced and shaped to fit into the pleats of the pleated filter media. The comb fingers (502) are glued on and integrated inside the pleats to increase the rigidity of the pleated filter media and reduce the deformation of the pleats during operation due the air pressure.

FIG. 6 shows the assembled filter media section (106-1). The assembled and completed filter media section comprises an additional compressible seal (601) attached over the border edge seals (301 and 302) to ensure that the sides of the filter sections are well sealed and are sufficiently supported. The seal (601) over the edge seals 108, 109-A, and 109-B prevents any chance of air leak around the filter media section. The seal (601) is a compressible gasket of suitable material, preferably of the same material as the filter media and is attached over the edge seals of the filter media section by hot glue or hot forming. The additional compressible seal (601) also ensures ease of handling of the replacement sections.

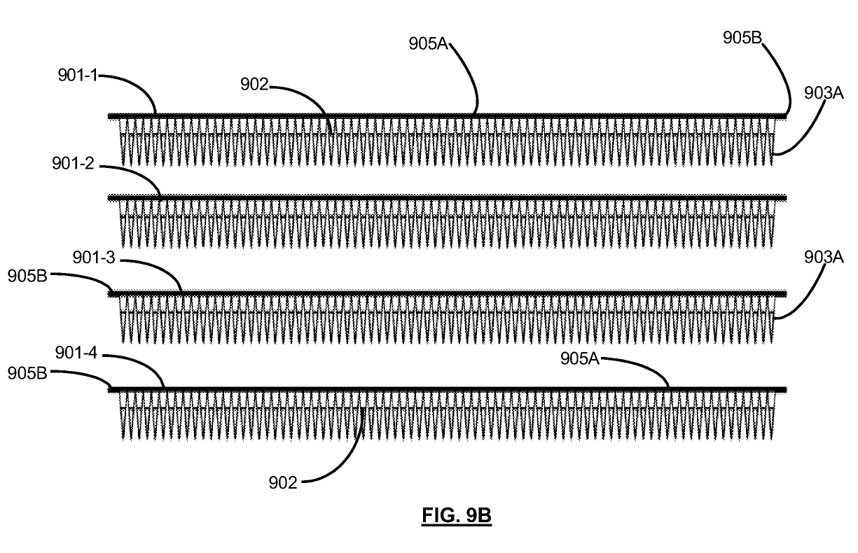

FIG. 7 shows the back to back placement of two filter media sections (106-1 and 106-2) before attaching the filter media sections together by interlacing the respective pleats for compact storage, reducing the storage volume of storage by 20 to 46%. The volume of the two filter sections (106-1 and 106-2) are twice the volume of one of the individual filter media sections (106-1) when the filter media sections are placed and stacked back to front with rigid non-die cut side panels to prevent damage to the pleated filter media for transport and storage.

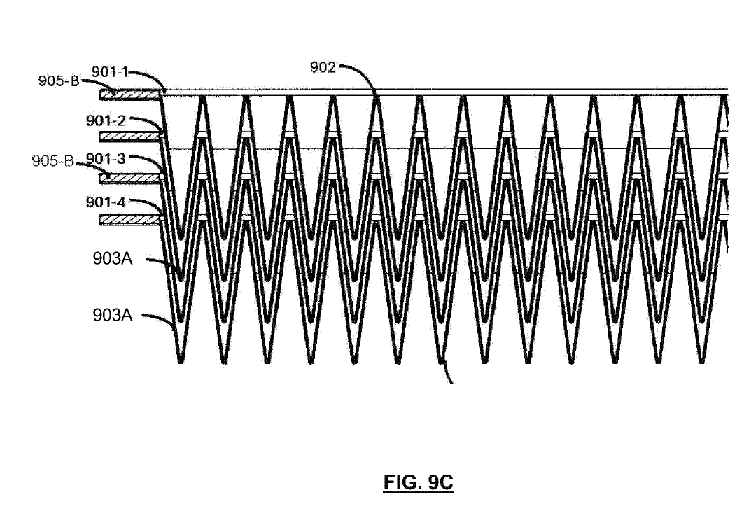

FIG. 8 shows the example method of interlacing the pleats of placing the two filter media sections (106-1 and 106-2) back to back for storage and shipping. The filter media sections are protected by the die cut side panels and made rigid by the comb structures (602-B) integrated into the pleats. The rigidity introduced enables the pleated material of the two filter media sections (106-1 and 106-2) to be placed back to back with the pleats interlaced, without damage to the pleats. The back to back packing with the interlaced pleats of the filter media sections reduces the volume taken by two of the filter media sections by 20 to 46%, making it less expensive to pack, transport and store the replacement sections.

Although, the 4” and 5” filter media and the stabilization of the pleats of these filter media during storage and application has been discussed, the principles described herein may be applied to other filter media. For example, filter media with depth of 4 inches or greater may incorporate the principles disclosed herein. In addition, the 1” and 2” filter media described for use in the frame U.S. Patent No. 12,539,484, hereby incorporated by reference in its entirety, can also be manufactured by the above described design allowing the media to be stored in a stacked form to reduce the storage volume needed.

A pleat having a short depth of 1 to 2 inches allows the media to be stored in a stacked form front to back to reduce the storage volume needed. The shorter depth eliminates the need for combs and allows the front to back stacking of the 1 to 2” deep media with interleaving of pleats. FIGS. 9A-9D show how the stacking of shorter 1 or 2 inch filter media can be done in accordance with the disclosed principles herein. FIG. 9A is a perspective view of four filter media 901-1 to 901-4 ready to be interleaved. FIG. 9B shows a side view of the four filter media 901-1 to 901-4 ready to be interleaved along the line X-X in FIG. 9A.

In this example each of the four filter media sections 901-1 to 901-4 have one or two inch deep filter media pleats. Each of the filter media sections, such as the filter media 901-1, are shown as being made of two filter media strips 902 joined along one of their long sides at a joint 904. The joint 904 forms a folding crease for the foldable disposable pleated filter media section 901-1. Each filter media strip 902 has an edge seal 905A along the long side connected at the joint 904 to form the folding crease for a first folding of the foldable disposable filter media section and an edge seal 905B along the narrow side of each of the filter media strip. These edge seals are typically made by hot forming of the filter media material. The pleats (903A) of the filter media strips extend from one long edge to the other long edge of each filter media strip. A side (903B) of the last pleat is at the narrow side of the filter media strip. Edge seals (905B) extend out from the pleated area of the filter media strip edge shown along the narrow side and along the long sides as 905A. The open pleats at the top of the two strips and the closed end pleats 903B at the bottom end of the filter strips forming the filter media 901-1 are shown in FIG. 9A-9B.

FIG. 9C is a side view of the four 1 or 2 inch filter media sections 901-1 to 901-4 interleaved and stacked front to back for compact storage. Since the pleats of the filter media sections are 1 to 2 inches in depth, there is no need for integrating a comb for retaining the structural integrity of the pleats. This allows more than two filter media sections to be stored front to back with interleaved pleats as shown in FIG. 9C and 9D with four filters. FIG. 9D is a close-up perspective view of the four filter media sections 901-1 to 901-4 interleaved and stacked for compact storage. As shown in the FIGS. 9C and 9D the filter media 901-1 to 901-4 may be stored with the pleats interleaved to reduce the volume taken by the stored filter media. Since the filter media depth is 1” or 2” in this example there is no requirement for a comb as in the case of 4” and 5” filter media for the pleats of the example filter media 901-1 to retain their shape and structural integrity when stored and used. Hence a plurality of filter media sections can be stored front to back with interleaved pleats as shown in FIGS. 9C and 9D to reduce the storage volume.

Although the disclosed embodiments have been illustrated and described with respect to one or more implementations, equivalent alterations and modifications will occur or be known to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application.

While various embodiments of the present disclosure have been described above, it should be understood that they have been presented by way of example only, and not limitation. Numerous changes to the disclosed embodiments can be made in accordance with the disclosure herein, without departing from the spirit or scope of the disclosure. Thus, the breadth and scope of the present disclosure should not be limited by any of the above described embodiments. Rather, the scope of the disclosure should be defined in accordance with the following claims and their equivalents.

What is claimed is:

1. An air filter media comprising:
a plurality of pleated filter media sections of deep depth configured to be inserted and enclosed in a filter frame, each filter media section having a top end, a bottom end, and opposing sides;
wherein the top end of each of the filter media sections comprise a plurality of pleats, wherein each of the plurality of pleats has an opening at the top end of the filter media section for unfiltered air entry;
wherein the plurality of pleats at the bottom end of each of the filter media sections comprise closed pleats allowing air within the pleats to filter through the filter media and exit the filter media section as filtered air;
wherein each of the plurality of pleats have an open end at the top end and a closed end at the bottom end having a triangular cross section;
wherein the plurality of pleats include open pleat edges on the opposing sides of the filter media;
a plurality of semi-rigid side seals, each having a plurality of triangular shapes conforming to a cross-section of the pleats, the seals covering and closing the open side edges of each of the pleats of each of the plurality of sections of filter media; and
wherein the bottom ends of the filter pleats of one filter media section are insertable between the bottom ends of the filter pleats of a second filter media section allowing back to back stacking of the air filter media sections.

2. The air filter media section of claim 1, further comprising a rigid comb configured to be inserted and integrated into the pleats.

3. The air filter media section of claim 2, wherein integration of the comb includes gluing the comb into the pleats of the filter media pleats to provide rigidity and structural integrity to the deep pleats of the filter media section.

4. The air filter media of claim 2, wherein the rigid comb includes a spine and a plurality of comb fingers that extend into the pleats of the filter media section and are glued in place.

5. The air filter media of claim 1, wherein the side seals are glued to the open side edges of the pleats to close them and prevent an air leak.

6. The air filter media of claim 5, wherein the top of the side seals for closing the open side edges of the pleats of each of the plurality of sections of filter media provide a border edge seal for the corresponding two sides of the filter media section.

7. The air filter media of claim 6, wherein the border edge seals of the remaining two sides of the filter media section are formed by hot press of the filter media.

8. The air filter media of claim 1, wherein the semi-rigid side seals are fabricated from a material of higher rigidity and of higher filtration efficiency than the rigidity and filtration efficiency of a filter media material used for the pleats of the filter media section.

9. The air filter media of claim 1, further comprising an additional compressible seal attached over the border edge seals of the filter media section to prevent air leaking around the air filter media section when the filter media section is enclosed in a filter frame and the filter is in operation filtering air.

10. The air filter media of claim 1, wherein the deep depth filter pleats have a depth of between 4 to 6 inches.

11. An air filter for deep depth filter media comprising:
one or more deep depth filter media sections, wherein each of the one or more deep depth filter media sections comprise:
a plurality of deep depth filter pleats, each pleat being made of filter media material and having a closed bottom end and an open top end with a triangular cross section, wherein each of the deep depth filter pleats extend from one side of the filter media section to the opposite side and each of the deep depth filter pleats have two open side edges;
one or more combs, each comprising a rigid spine with comb fingers fitting the triangular cross section shape of the pleats extending therefrom, wherein the one or more combs are inserted into the deep depth filter pleats and integrated by glue to the inside of the pleats to provide rigidity and structural integrity to the plurality of deep depth filter pleats; and
two semi-rigid side seals, made from a material having a higher filtration efficiency than the filter media, die cut to fit and cover only the two open side edges of the plurality of pleats of one of the filter media sections; and
a frame having a frame top and a frame base, wherein the frame base includes a filter bottom with one or more compartments, each compartment holding one of the deep depth filter media sections; and
wherein the bottom of the filter pleats of a first filter media section are insertable between the bottom of the filter pleats of a second filter media section allowing back to back stacking of the filter media sections.

12. The air filter of claim 11 wherein the plurality of deep depth filter pleats are between 4 and 6 inches in depth.

13. The air filter of claim 11, wherein the frame includes one or more compartments for holding the deep depth filter media sections, wherein the compartments are separated by a divider.

14. The air filter of claim 12, wherein the divider holds a differential air pressure sensor.

15. The air filter of claim 11, wherein the frame base includes one or more communication modules, and power supply modules used in a filter system.

16. The air filter of claim 11 wherein the frame top is connected by hinges to one side of the frame base.

17. The air filter of claim 11, wherein each of the one or more filter media sections have an outer border edge seal that is compressed between an edge of the frame base or a divider in the frame base and an edge or a corresponding divider, to the one in the frame base, of the frame top when the filter is closed to prevent air leak around the filter media section and hold the filter media section securely within the closed filter frame during operation.

18. An air filter media section comprising:
a plurality of 1 to 2 inch deep filter media sections, wherein each of the plurality of 1 to 2 inch deep filter media sections comprise a plurality of 1 to 2 inch deep filter pleats;
wherein the filter media sections are storable with interleaved filter pleats in a front to back stacking; and
wherein the plurality of 1 inch to 2 inch deep filter media sections are sufficient rigid to prevent deformation when interleaved during the front to back stacking.

19. The air filter media section of claim 18, wherein the front to back stacking with interleaved pleats reduce the volume required for storing of the air filter media sections.

20. The air filter media section of claim 18, wherein the 1 to 2 inch deep filter media sections are foldable and disposable.
